(19) United States
(12) Patent Application Publication
(10) Pub. No.: US 2006/0142522 A1
(43) Pub. Date: Jun. 29, 2006

(54) Cationic water-soluble conjugated polymers and their precursors

(76) Inventor: Bin Liu, Goleta, CA (US)

Correspondence Address: TRASK BRITT, P.O. BOX 2550, SALT LAKE CITY, UT, 84110, US

(21) Appl. No.: 10/532,649

(22) PCT Filed: Oct. 23, 2003
(86) PCT No.: PCT/SG03/00252

§ 371 Date: Oct. 12, 2005

(30) Foreign Application Priority Data
Oct. 25, 2002 (SG) 200206545-6

(51) Int. Cl. C08G 77/00; C08G 73/00

(52) U.S. Cl. 528/10; 528/422

(57) ABSTRACT

Conjugated polymers of the formula(I) wherein: • R₁, and R₂ are identical or different and are each H, a straight or branched alkyl, alkoxyl, ester groups or cyclic crown ether groups having from 1 to about 22 carbon atoms; • A, B, E and F are identical or different and are each H, Si R′R″ or NR′R″ (but can not all be H or SiR′R″); R′, and R″ are independently selected from the group consisting of hydrogen, unbranched or branched alkyl or alkoxyl groups having 1 to about 12 carbon atoms, (C3 to C10) cycloalkyl groups; • C and D are identical or different and are each H (but can not both be H), O, S, CO, COO, CRR′, NR′, Si R′R″, wherein R′ and R″ are as defined above; • R₃, R₄, R₅, R₆, R₇ and R₈ are identical or different and are independently selected from linear or branched or cyclical saturated or unsaturated aliphatic moieties which may contain one or more heteroatoms and which may contain one or more aromatic groups, substituted or unsubstituted aromatic moieties; - G is hydrogen, halogen, boronic acid, boronate radical or an aryl moiety; • a and b are independent and each is a number from 0 to about 100; • x and y are also independent and each is a number from 0 to about 100; and • n is a number from 1 to about 1000.

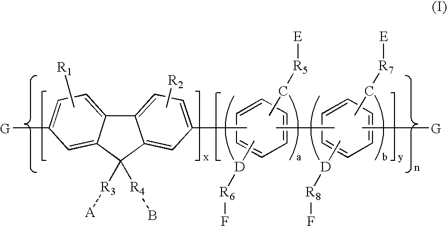

### CROSS-REFERENCE TO RELATED APPLICATIONS

This application claims priority to International Application No. PCT/SG2003/000252, filed Oct. 23, 2003, published in English as PCT International Publication No. WO 2004/037886 A1 on May 6, 2004, which claims priority to Singapore Patent Application No. 200206545-6 filed Oct. 25, 2002.

### TECHNICAL FIELD

The invention relates to cationic water-soluble conjugated polymers with ammonium-terminal groups. The invention further relates to a method of determining the water-solubility of such conjugated polymers by controlling the degree of quaternization of precursor polymers having amino-terminal groups.

### BACKGROUND OF THE INVENTION

Conjugated polymers have been widely used as light emitting and hole/electron transporting materials in light emitting diodes. In many applications, it is desirable that a conjugated polymer be capable of dissolution in common solvents. The solubility of conjugated polymers could be greatly improved by attaching flexible side chains or large substituents and, through the modification of the pendant groups, the physical, mechanical and processing properties of the materials could be tuned. Conjugated polymers which are soluble in organic solvents, such as chloroform, tetrahydrofuran, and benzene are known. However, for the fabrication of multilayer devices, in some cases, it is difficult to spin cast multiple layers of polymers because the first layer that is deposited can be dissolved during the spin-casting of the subsequent layers. It is essential to design polymers with high photoluminescence (PL) efficiencies while with different solubility in common organic solvents. It is preferable, where the application permits, to use water in connection with the manufacture, using and processing of a conjugated polymer, in order to avoid disadvantages involved in the use of organic solvents.

Conjugated polymers having solubility in water (or other polar solvents) may offer a number of new application opportunities. Potential applications of water-soluble conjugated polymers include the construction of active layers in organic light-emitting diodes through layer-by-layer self-assembly approach, as buffer layer and emissive layer materials in inkjet printing fabricated organic LEDs, and as highly sensitive fluorescent sensory materials in living bodies.

Ionic conjugated polymers (a new class of polyelectrolytes which consist of both polyions and electronically active conjugated backbones) are beginning to attract a great amount of interest because of the potential applications in fabricating photonic devices as well as in the development of highly efficient biosensors. The applications generally favor high molecular weights and high photoluminescence (PL) efficiencies and require different ionic types. Ionic water-soluble polymers have been synthesized by homo- and copolymerization as well as by polymer analogous reactions.

Water-solubility of semiconducting conjugated polymers was first demonstrated in 3-substituted polythiophenes and was then extended to poly(para-phenylene vinylene) (PPV)-based and poly(para-phenylene) (PPP)-based polymers. Water-soluble PPP derivatives have been investigated quite extensively.

To date, however, most of the available ionic conjugated polymers are polyanions containing the sulfonate or carboxylate functionality. It is desirable that cationic polymers be used, for instance in cases of multilayer deposition from solution, especially for those using self-assembly techniques. In addition, cationic polymers are particularly interesting for studying DNA and RNA related bio-species, because these are negatively charged polynucleic acids.

Recently, the synthesis of certain ammonium-functionalized polymers has been reported. However, this was limited to the poly(p-phenylene)s (PPPs) which are associated with small molecular weight and difficult purification processes.

Also, for different purposes, different degrees of solubility of the polymers may be desirable. There is a need for cationic polymers which are adapted to be modified, as desired, so as to control (or tune) the degree of solubility of the polymer. A method for achieving this is also required.

Accordingly, the present invention is directed towards different kinds of conjugated polymers, their cationic derivatives, and methods for controlling the water solubility of such polymers and their cationic derivatives.

### SUMMARY OF THE INVENTION

This is achieved by creating a new series of neutral luminescent materials with functionalized groups (such as amino groups) which, upon quaternization, lead to polymers which are soluble in water (or in other polar solvents). The post-polymerization steps not only permit the full structural characterization of the polymers in the neutral state, but they also provide the possibility of adjusting the cationic degree which in turn determines the solubility of the resulting polymers in organic solvents and water. Strictly speaking, the materials are substituted conjugated polymers in which a desired amount of suitable functionalized groups are incorporated into the side chains of the conjugated polymers.

This invention involves the use of a series of neutral polymers and their quaternized salts.

According to a first aspect of this invention, there is provided a conjugated polymer of the formula: 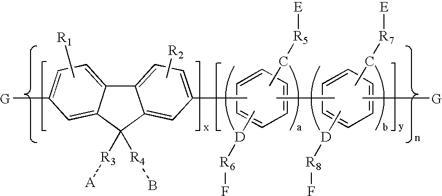
wherein:

R₁ and R₂ are identical or different and are each H, a straight or branched alkyl, alkoxyl, ester groups or cyclic crown ether groups having from 1 to about 22 carbon atoms. Preferably, R₁ and R₂ are H or straight or branched alkyl groups having 1 to about 12 carbon atoms. More preferably, R₁ and R₂ are alkoxyl groups with 1 to about 12 carbon atoms.

A, B, E and F (as the terminal groups), are identical or different and are each H, Si R′R″ or NR′R″ (but can not be all of H or SiR′R″) for the cationic polymers. Consequently, the precursor neutral polymers will contain one or more NR′R″ groups as the functional groups. These terminal groups are designed to introduce water solubility.

These polymers may be directly synthesized using monomers containing amino groups, or some of other functional groups such as Br or I which will react with amine to form the amino groups. R′ and R″ are independently selected from the groups consisting of hydrogen, unbranched or branched alkyl or alkoxyl groups having 1 to about 12 carbon atoms, (C3 to C10) cycloalkyl groups. It is preferred that R′ and R″ are C1 to C4 alkyl or alkoxyl groups. Preferably, A, B, E and F are independently selected from hydrogen or NR′R″ (but not all hydrogen), where R′ and R″ are as defined above.

C and D are identical or different and are each H (but can not be both H), O, S, CO, COO, CRR′, NR′, Si R′R″, wherein R′ and R″ are as defined above.

R₃, R₄, R₅, R₆, R₇ and R₈ are identical or different and are independently selected from linear or branched or cyclical saturated or unsaturated aliphatic moieties which may contain one or more heteroatoms and which may contain one or more aromatic groups, substituted or unsubstituted aromatic moieties. R₃ and R₄ are preferably C4-C8 linear or branched aliphatic chains which may contain one or more heteroatoms and which may contain one or more aromatic groups, substituted or unsubstituted aromatic moieties. More preferably, R₃, and R₄, are C2-C12 alkoxyl groups. R₅, R₆, R₇ and R₈ are preferably C1 to C8 linear or branched aliphatic chains which may contain one or more heteroatoms, and more preferably, R₅, R₆, R₇ and R₈ are C2-C12 alkoxyl groups.

G is typically selected from those reactive groups that are capable of undergoing chain extension. Preferably, G is hydrogen, or an aryl moiety which may contain halogen, boronic acid, or boronate radical. Preferably, G is hydrogen or an unsubstituted or substituted aryl moiety which does not contain the above mentioned groups.

x and y are independent and each is a number from 0 to about 100 and preferably 0 to about 20 and more preferably from 0 to about 10. a and b are also independent and each is a number from 0 to about 100, and preferably from 0 to about 10. n will range from 1 to about 1000 and preferably from 1 to about 50.

The attachment of R₃, R₄, R₅, R₆, R₇ and R₈ either on the fluorene ring or on the phenylene ring, enables good solubility of the neutral polymer, which facilitates the post-polymerization approach in tetrahydrofuran (THF) and dimenthyl sulfoxide (DMSO). Preferably, R₃, R₄, R₅, R₆, R₇, and R₈ are alkoxyl groups with 2 to about 10 carbon atoms, since longer aliphatic chains may reduce the water-solubility of the resulting polymers. Preferably, the attachment of C and D are on the 2 and 5 positions and the linkage between fluorene and phenylene is on the 1 and 4 positions.

In one embodiment having liquid crystalline properties, the fluorene portion of Formula 1 is 9,9-dihexylfluorene, C and D are oxygen atoms, and R₆ and R₇ are C2 to C12 alkyl groups, and the terminal groups E and F are ethyl amino groups. The corresponding water-soluble polymers have also shown liquid crystalline properties.

The polymers may either be homopolymers or copolymers (such as random copolymers or alternated copolymers).

According to a second aspect of the invention, there is provided a method of increasing the solubility, in polar solvents, of the polymers described above by quaternizing terminal amino groups of the polymer. Typically the quaternization is effected by treating the polymer with an alkyl bromide, such as bromoethane. In one embodiment of this method, the polymer may be treated with bromoethane by stirring the polymer with the bromoethane in dimethyl sulfoxide (DMSO) and tetrahydrofuiran (THF). The mix of DMSO and THF solvents may be in a ratio of 1:4 and the stirring may be effected at a temperature of about 50° C. for about five days. In another embodiment of this method, the polymer may simply be treated with bromoethane by stirring the polymer with bromoethane in THF solvent. In this case, the stirring may be effected at about room temperature for about 24 hours. The above two embodiments result in different quaternization degrees of the polymer.

The method may further comprise the steps of:
evaporating the solvents;
precipitating the quaternized polymer;
washing the polymer; and
drying the polymer.

The polymer may be precipitated by adding acetone followed by centrifugation. The washing may be effected with chloroform and/or acetone.

According to a third aspect of this invention, there is provided a method of forming a conjugated cationic polymer having a desired solubility in a given solvent, said method comprising:
providing a conjugated polymer as described above;
determining a desired solubility of the polymer in the given solvent; and
quaternizing terminal amino groups of the polymer to an extent necessary to increase the solubility of the polymer to the desired solubility.

Preferably, quaternization is performed to an extent so that between about 30% and about 80% of the terminal amino groups undergo quaternization.

The quaternization may be effected by treating the polymer with an alkyl halide, such as bromoethane. This treatment can be effected by stirring the polymer with the solvents and under the conditions described above.

This method of forming a conjugated cationic polymer may further comprise the steps of:
evaporating the solvents;
precipitating the quaternized polymer;
washing the polymer; and
drying the polymer.

The precipitation and washing may be effected in the manner described above.

According to a fourth aspect of this invention, there is provided a method of forming a conjugated cationic polymer, said method comprising:
providing monomer precursors of a polymer (being any of the polymers described above);
quaternizing terminal amino groups of the monomer precursors; and
synthesizing the cationic polymer from said quaternized monomer precursors,

This synthesis is typically effected by the Suzuki coupling reaction. As is well known, this is a Pd-catalyzed cross-coupling reaction between an aromatic boronic acid derivative and an aromatic halide to yield a corresponding biphenyl.

This method may further include the steps of determining the desired solubility of the cationic polymer and calculating the amount of monomer precursors required to form a cationic polymer having the desired solubility. Alternatively, the method may further include the step of determining the desired solubility of the cationic polymer, and wherein the terminal amino groups are quaternized to a degree sufficient to result in the cationic polymer having the desired solubility.

According to a further aspect of this invention, there is provided a conjugated cationic polymer, derived from the polymer described above, said cationic polymer comprising repeating units of the formula: 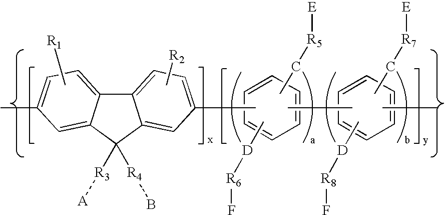
wherein:

(a) R₁, R₂, R₃, R₄, R₅, R₆, R₇, R₈, C, D, a, b, x and y are as defined above; and

(b) in at least one of the repeating units, at least one of A, B, E and F is NR′R″R′″, wherein R′, R″ and R′″ are independently selected from the group consisting of hydrogen, unbranched or branched alkyl or alkoxyl groups having 1 to about 12 carbon atoms, and (C₃ to C₁₀) cycloalkyl groups.

It is also preferred that, in at least one of the repeating units, at least one of A, B, E and F is ammonium. Typically, this ammonium will have been quaternized from at least one amino substituent of the polymer. It is further preferred that, in more than one of the repeating units, at least one of A, B, E and F is ammonium. It is further preferred that, in more than one of the repeating units, more than one of A, B, E and F is ammonium.

According to a further aspect of this invention, there is provided a polymeric salt comprising a cationic polymer, being a cationic polymer as described above.

According to a further aspect of this invention, there is provided an ionic composition comprising a cationic polymer, being a cationic polymer as described above.

The tunable water-solubility of the polymers was realized through the quaternization of the amino group (or groups) through the post-polymerization steps.

These steps enable there to be some control over the extent to which cations are formed, which in turn determines the solubility of the polymers in organic solvents and water. A higher degree of quaternization was accompanied by better solubility in polar solvents with improved charge transporting properties. Both the neutral and the quaternized polymers of fluorene-co-phenylene series, which have two or more carbon atoms on the phenylene ring, exhibit liquid crystalline behavior. This gives this series of polymers potential application in polarized light emitting diodes (PLEDs). For the quaternized water-soluble polymers, because of their charged nature and related water-solubility, these molecules are potential candidates that could be processed at the molecular level by the extremely versatile layer-by-layer sequential adsorption technique, and serve as charge transporting layers. The sensitivity of polycations upon the interaction with polyanions also endows this kind of materials with potential application in biosensors.

### BRIEF DESCRIPTION OF THE DRAWINGS

In order that the present invention may be more clearly understood, preferred forms will be described with reference to the following drawings in which:

FIG. 1 is a graph showing the NMR spectra of the polymers formed according to Schemes 1 and 2 (see below);

FIG. 2 is a graph showing the representative UV and PL spectra of 3 of the neutral polymers referred to in FIG. 1 and their quaternized salts;

FIG. 3 shows the LC state of the neutral polymer under PLM; and

FIG. 4 shows the representative cyclic voltammogram spectra for the polymers referred to in Scheme 1 (below).

### DETAILED DESCRIPTION OF THE INVENTION

In this invention, conjugated polymers are characterized by unsaturated organic-based backbones with extensive π-electron delocalization.

Cationic water-soluble polymers refer to those polymers with cationic functional groups attached at the polymer side chains, which are introduced to realize water solubility.

The term “post-polymerization” refers to further modification of the polymers after the designated monomers were polymerized. In this invention, it means the quaternization of the terminal amino (NR′R″) groups, preferably with alkyl bromide.

The term “quaternization” means the formation of ammonium salts between amino groups and alkyl bromide or any of the organic or inorganic acids. In this invention, quaternization with alkyl bromide is particularly preferred.

The term “quaternization degree” is defined as the percentage of the amino groups that have been quaternized.

The polymers of the present invention, which may be homopolymers or copolymers of polyfluorene, have a conjugated backbone structure. The functional group of ammonium salt was introduced to the side chain to realize the water-solubility. In applications requiring good water-solubility, usually at least 60% of the side chains are functionalized with ammonium salts.

The neutral polymers were synthesized through the Suzuki reaction from the corresponding monomers. Through adjusting the post-polymerization conditions, quaternized salts with different cationic degrees were synthesized.

Synthetic examples are given in respect of one specific polymer under the Formula 1 by using two methods. The first is through post-polymerization steps based on the pre-synthesized neutral polymer. And the second approach is the direct polymerization of quaternized monomer. The schemes are illustrated in Scheme 1 and 2, respectively. The synthetic routes are explained as follows.

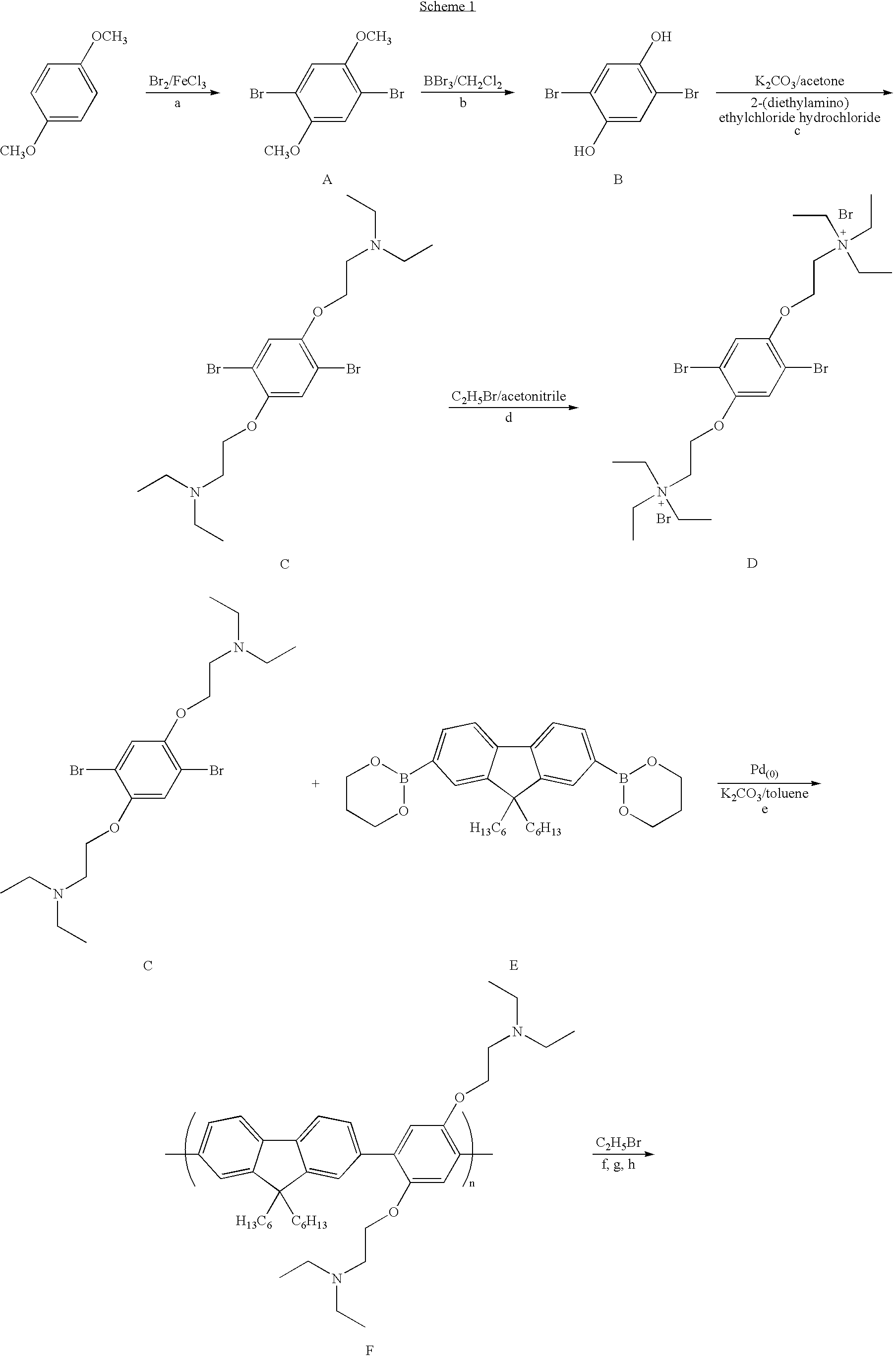

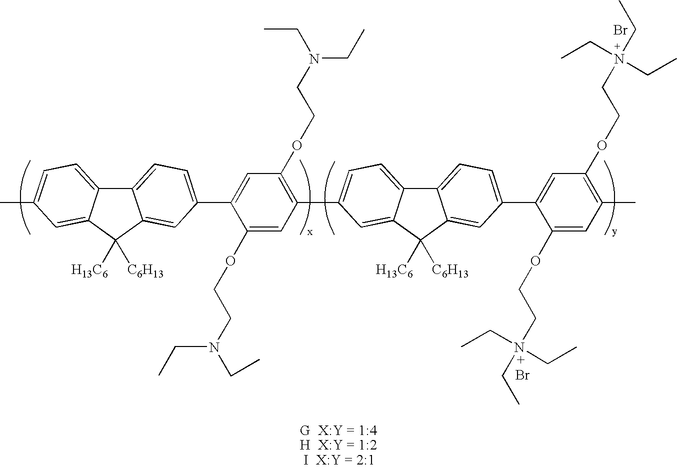

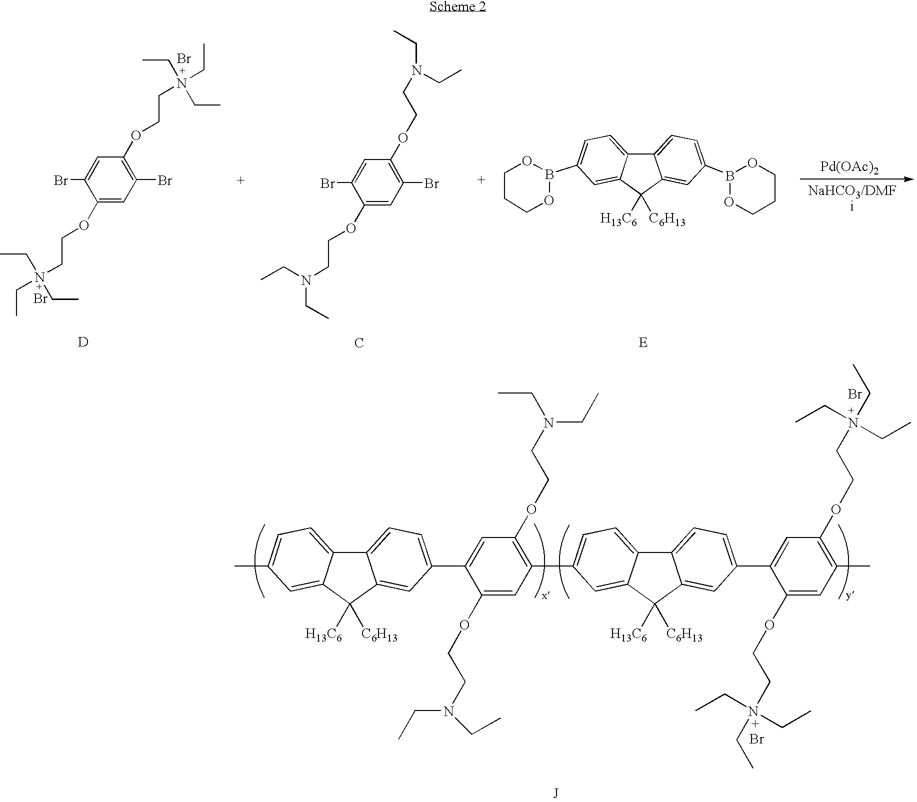

### Scheme 1

2,5-Dibromohydroquinone (B) was obtained by the treatment of 1,4-dibromo-2,5-dimethoxybenzene (A) with BBr₃ in dry dichloromethane and the 1,4-dibromo-2,5-dimethoxybenzene (A) was synthesized through the direct bromination of dimethoxybenzene as the starting material. Compound C, 2,5-bis[3-(N,N-diethylamino)-1-oxapropyl)-1,4-dibromobenzene] was prepared by reactions between 2,5-dibromohydroquinone (B) and 2-(diethylamino)ethylchloride hydrochloride in refluxing acetone in the presence of excess anhydrous potassium carbonate for three days. After twice recrystallization from methanol, Compound C was obtained as colorless needles, which upon stirring with bromoethane in acetonitrile afforded a water-soluble monomer, Compound D, as a white precipitate. The resulting precipitate was collected on a frit at reduced pressure and dried in vacuo for two days before use.

In step a of Scheme 1, the thus obtained substituted phenylene or fluorene are dihalogenated, preferably brominated or iodinated, and preferably at 2,7-position for fluorene unit or 2,5 position of phenylene unit, utilizing a common halogenation reagent, such as bromine and iodine.

In step c of Scheme 1, the functional group was directly introduced into the obtained dihalogenated phenylene or fluorene. For the realization of cationic water-soluble polymers, the functional groups are aliphatic or aromatic amine groups, including those N atom-containing aromatic rings, such as pyridine. The functional groups could be introduced through different methods, such as that a Br or I group is attached to the end of the alkyl or the alkoxyl chain, which is then reacted with amines to form the amino groups. However, preferably, the functional amino groups are directly introduced to the monomer.

In step e, the synthesis of the neutral polymer depicted in Scheme 1 is based on the Suzuki coupling reaction (N. Miyaura and A. Suzuki, Chemical Reviews, Vol. 95, 2457 (1995); M. Inbasekaran, W. Wu, E. P. Woo, U.S. Pat. No. 5,777,070), which was carried out in a mixture (3:2 in volume) of toluene and aqueous potassium carbonate solution (2 M) containing 1 mol % Pd(PPh₃)₄ under vigorous stirring at 85-90° C. for 48 hours in a nitrogen atmosphere. A small amount of tetrabutylammonium chloride was added as the phase transfer catalyst to improve the molecular weight. It also might be possible that the polymers were synthesized through a nickel-mediated coupling reaction, with dibromonated monomers. (E. P. Woo, W. R. Shiang, M. Inbasekaran, G. R. Roof, U.S. Pat. No. 5,708,130).

In the step of either f or g or h in Scheme 1, by treating the neutral polymer with bromoethane in different solvents, and by controlling the reaction temperature, the quaternization degree could be adjusted, and consequently the water-solubility of the resulting polymers could be tuned. From the post-polymerization, polymers with different amount of quaternized salts can be obtained.

### Scheme 2

To synthesize polymers with ammonium functional groups, the other method involves introducing the ammonium group into the side chain of monomers and a desired amount of the ammonium functionalized monomer then undergoes polymerization. It is preferable that this is done together with other suitable monomers, and it is more preferable that this is done with the monomer with terminal amino groups, to provide polymers with different quaternization degrees.

In step i of Scheme 2, the polymer was synthesized by using similar conditions as described in the step e of Scheme 1, with a desired amount of quaternized salts involved. Consequently, the quaternization degree could be exactly determined, however, the molecular weight of the polymers are lower by using the method of Scheme 2.

Preferably, the crude polymers obtained by the two approaches should be carefully purified by washing with acetone in a Soxhlet apparatus for 24 hours to remove oligomers and catalyst residues. The purified polymers should then be dried under reduced pressure at room temperature. After purification and drying, the neutral polymers were obtained as white fibrous solids, while the quaternized salts were pink. The neutral polymers that were prepared had molecular weights ranging from about 30,000 to about 70,000. However, it is expected that polymers of the present invention will have a molecular weight in the range of from about 20,000 to about 50,000, with the number of amino functional groups being between about 25 and 50 in each molecule. Both the neutral and quaternized salts are air-stable. The terminal groups in the neutral polymers provided the possibility to synthesize water-soluble polymers through the post-polymerization approach.

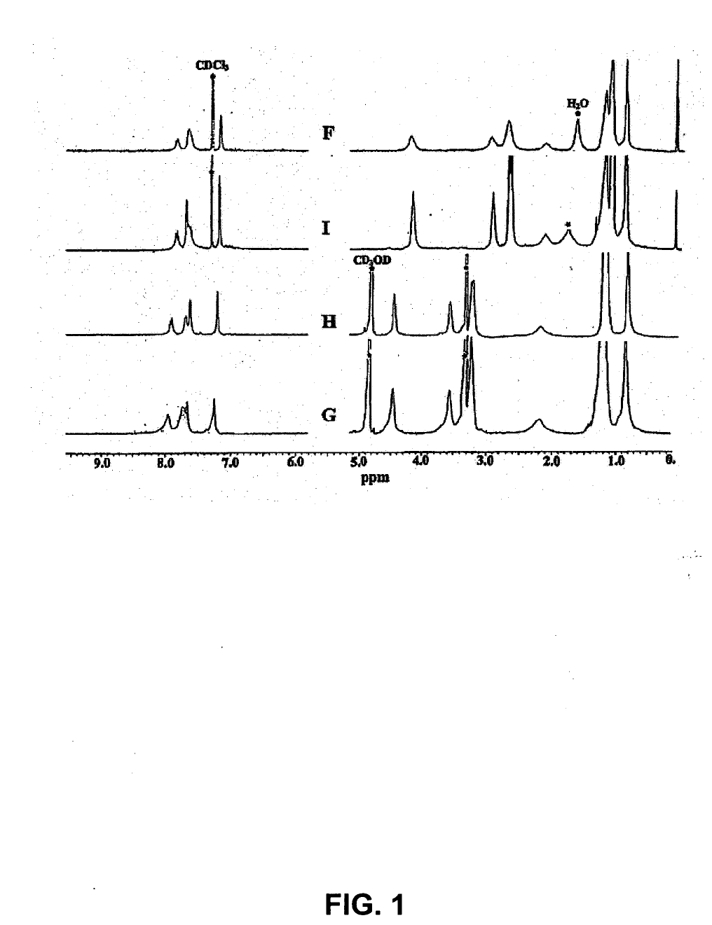

Conversion of the neutral polymer F to the final water-soluble polymer G was achieved by stirring the neutral polymer with bromoethane in dimethyl sulfoxide (DMSO) and tetrahydrofuran (THF) (1:4) at 50° C. for five days. Following the same reaction conditions for G with less reaction time afforded another polymer H with a quaternization degree of about 60%. However, stirring the neutral polymer F with bromoethane in THF at room temperature for 24 hours afforded a new polymer I with a quaternization degree of about 30%. The quaternization degree was estimated from the respective ¹H NMR spectrum. The NMR spectra of the polymers are also shown in FIG. 1.

The obtained neutral polymers readily dissolve in common organic solvents, such as THF, chloroform, toluene, and xylene, but they are insoluble in DMSO, methanol and water. After quaternization, the resulting polymers show different solubility characteristics as compared to the neutral polymer. For example, as shown in Scheme 1, polymer G, with a quaternization degree of 80%, is completely soluble in DMSO, methanol, and water, but insoluble in CHCI₃ and THF. Polymer G could be recovered from a water solution by evaporation of the water. Interestingly, solubility is also found for the polymers with different quaternization degrees, such as H and I. With a quaternization degree of 30%, polymer I has a reduced solubility in THF, chloroform, toluene, and xylene, as compared to the neutral polymer F, while it also has poor solubility in the polar solvents. Ongoing with increasing quaternization degrees, the solubility of the polymers in common organic solvents decreased whilst the solubility in polar solvents, such as DMSO and water, increased gradually. With the increased quaternization degree, the polymer G has better water solubility as compared to that of H.

Through control of the quaternization conditions, polymers with different quaternization degree have been synthesized. Accordingly, polymers having a desired solubility (in polar or non-polar solvents) can be synthesized by controlling the degree of quaternization of the polymers.

Solutions of the neutral polymers in THF and the quaternized polymers in water or methanol have been prepared with the concentration up to 15%, preferably 10%, regardless of the molecular weight.

By using such solutions, uniform and transparent films can be cast on different substrates, such as glass, quartz, or indium-tin oxide, and even polymer substrates for either the neutral or the quaternized polymers. Multiple layers of such films may be deposited on the relevant substrate. Where it is important that a polymer in one layer does not get transported (or dissolved) in an adjacent layer, appropriate selections of solvent and dissolved polymer (quaternized to the determined degree) can achieve this. The films may be cast from a solution of the polymer in the above mentioned solvents by using any of the known methods, such as the spin-cast technique.

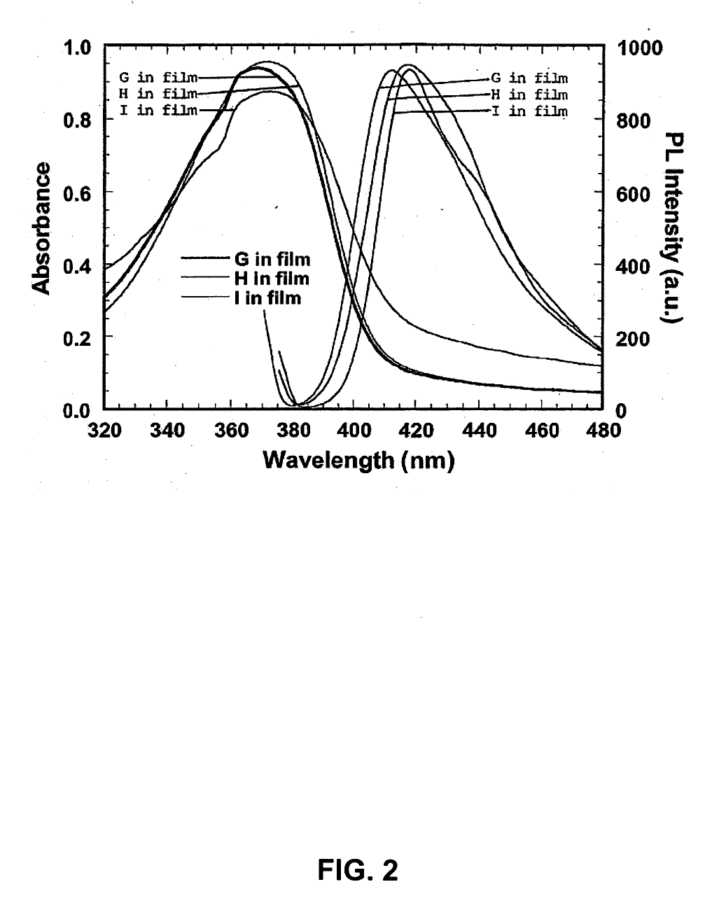

The obtained polymers are blue emission polymers. For the neutral polymers, such as F, its film exhibited the absorption maximum at 370.5 nm. Its PL spectrum peaked at 414 nm, with a small shoulder at 428 nm. The representative UV and PL spectra are shown in FIG. 2.

Normally, the quaternized salts show a spectral blue shift as compared to the neutral polymer, and higher quaternization degree also induces spectral blue shift. The representative UV and PL spectra are also shown in FIG. 2. For the polymers described in Scheme 1, both the neutral and the quaternized polymers are blue emission polymers, while if the fluorene monomer is replaced by the thiophene moieties, green emission is realized.

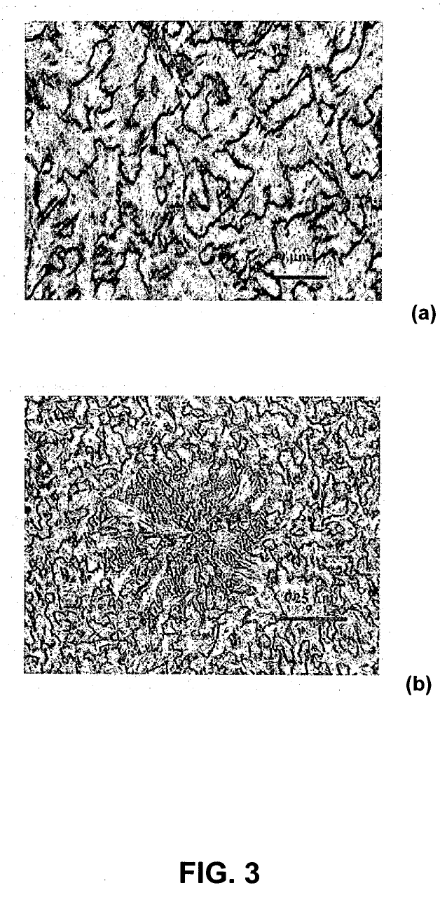

It was also found that for the polymers as described in Scheme 1, both drop-cast films of the neutral and the quaternized polymers have shown liquid crystalline structures at room temperature. The LC state of one quaternized polymer under PLM was shown in FIG. 3.

Liquid crystalline polymers have technological potential in areas ranging from microelectronics to biotechnology. The polymers can be used to fabricate different types of devices, including polarized light-emitting diodes.

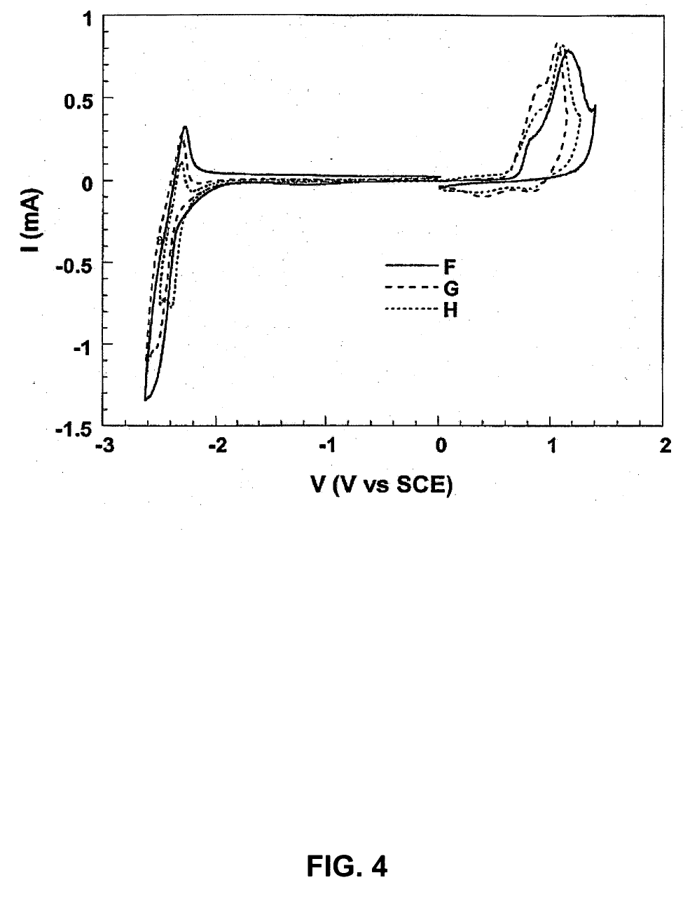

In addition, polymers of the present invention offer a specific advantage over conventional conjugated polymers for use as charge transporting materials. Take the neutral polymer and the water-soluble polymers, such as F and G or H for example, all the three polymers have similar HOMO and LUMO energy levels, estimated from their cyclic voltammograms. The representative cyclic voltammograms are shown in FIG. 4. Polymers with similar band gap, while with different cationic degree may provide more choices for a suitable balanced charge transporting as in the fabrication of multilayer LEDs.

### EXAMPLES

This invention will be further described by reference to the following examples. These examples are intended as an illustration of a preferred form of the invention and they do not constitute a limitation of this invention.

### Example 1

### Preparation of 1,4-Dibromo-2,5-Dimethoxybenzene (A)

In a round-bottom flask equipped with a water condenser was added 1,4-dimethoxybenzene (13.8 g, 0.10 mol) and 200 mL of CCI₄ under argon. The mixture was stirred until all solids disappeared. Into the solution was added dropwise 12.4 mL of bromine (0.24 mol) mixed with 80 mL of CCI₄ for 30 minutes. The mixture was stirred for 12 hours. HBr gas was collected in saturated aqueous NaOH as it evolved. A white-colored precipitate was collected by filtration and washed with cold ethanol. The filtrate was neutralized by adding aqueous K₂CO₃ with vigorous stirring until the solution turned colorless. The CCI₄ solution was separated and the product was recovered by evaporation. The crude 1,4-dibromo-2,5-dimethoxybenzene was recrystallized from boiling ethanol. ¹H NMR (300 MHz, CDCI₃, ppm): δ 7.19 (s, 2H), 3.80 (s, 6H). C₈H8O₂Br₂ Anal. Calcd: C, 32.43; H, 2.70; Br, 54.05. Found: C, 32.80; H, 2.85; Br, 53.88.

### Example 2

### Preparation of 1,4-Dibromohydroquinone (B)

Into a 500 mL round-bottom flask equipped with a water condenser were added 1,4-dibromo-2,5-dimethoxybenzene (14.8 g, 50 mmol) and 150 mL of dry CH₂CI₂ under argon. The mixture was stirred until all solids disappeared. Dropwise, into the solution was added 105 mL of 1.0 M boron tribromide of CH₂CI₂. The reaction was refluxed at 45° C. for 12 hours and then cooled to room temperature. The solution was slowly poured into ice water and stirred vigorously for 30 minutes. An off-white precipitate was separated by filtration and washed with water. Recrystallization from acetic acid and drying in vacuo at 60° C. for 12 hours afforded pure 1,4-dibromohydroquinone (10.7 g, 79%) as white crystals. ¹H NMR (300 MHz, CDCl₃, ppm): δ 7.28 (s, 2H), 4.95 (br, 2H). C₆H₄0₂Br₂ Anal. Calcd: C, 26.87; H, 1.35. Found: C, 26.88; H, 1.85.

### Example 3

### Preparation of 2,5-Bis[3-(N,N-Diethylaamino)-1-Oxapropyl]-1,4-Dibromobenzene (C)

A 500 mL round bottom flask with magnetic spin bar was charged with anhydrous potassium carbonate (72.0 g, 521.0 mmol), 2-(diethylamino) ethylchloride hydrochloride (22.6 g, 131.0 mmol), and 1000 mL of acetone. The stirred mixture was sparged with nitrogen for 15 minutes followed by the addition of 2,5-dibromohydroquinone (15.0 g, 56.0 mmol). After 15 minutes additional sparging, the reaction mixture was brought to reflux for three days. Acetone was removed and the reaction mixture was diluted with 500 mL of water, dissolving all salts. The product was extracted with ether, and the combined organic layer was washed with 10% NaOH (aq.) (2×100 mL), water (2×200 mL), and brine (1×200 mL). The solution was dried over MgSO₄, filtered, and stripped of solvent by vacuum evaporation to yield crude oily solids. The crude solid was recrystallized from MeOH/H₂O to afford Compound C (12.5 g, 48.4%) as white crystals. ¹H NMR (300 MHz, CDCI₃, ppm): δ 7.12 (s, 2H), 4.04-3.99 (t, 4H, J=6.03 Hz), 2.92-2.88 (t, 4H, J=6.22 Hz), 2.68-2.61 (q, 8H, J=7.09 Hz), 1.10-1.05 (t, 12 H, J=7.21 Hz). C₁₈H₃₀N₂O₂Br₂ Anal. Calcd: C, 46.37; H, 6.49; N, 6.01; Br, 34.28. Found: C, 46.65; H, 5.99; N, 5.99; Br, 34.32.

### Example 4

### Preparation of 2,5-Bis[3-(N,N,N-Triethylammonium)-1-Oxapropyl]-1,4-Dibromobenzene Dibromide (D)

A mixture of 2,5-bis[3-(N,N-diethylamino)-1-oxapropyl]-1,4-dibromobenzene (4.66 g, 10 mmol) and 20 ml of bromoethane in 100 ml of acetonitrile was heated at 40° C. for two days, when some white color precipitate appeared, an additional 10 ml of bromoethane was added, and the mixture was kept stirring for another five days at room temperature. The resulting precipitate was collected on a frit at reduced pressure and dried in vacuo at 50° C. for 24 hours to afford Compound D (5.45 g, 80%) as fine white crystals. Mp: 255.0-256.8° C. ¹H NMR (D₂O, 300 MHz, ppm) δ 7.77 (d, 2H, J=7.55 Hz), 7.72 (s, 2H), 7.69 (d, 2H, J=7.48 Hz), 4.25-4.16 (t, 8H, J=5.36 Hz), 2.07(m, 4H, J=5.33 Hz), 1.98 (m, 4H, J=4.09 Hz), 1.20-0.90 (m, 12H), 0.76 (t, 6H, J=6.83 Hz). 0.56(m, 4H). ¹³C NMR(CDCI₃, 75 MHz, ppm) δ 151.17, 140.03, 139.18, 132.44, 128.10, 123.53, 119.83, 109.94, 55.09, 40.28, 31.53, 31.43, 30.82, 29.62, 29.04, 28.71, 23.76, 22.48, 13.94, 13.88. Anal. Calcd for C₃₁H₄₄O₄B₂: C, 74.13; H, 8.83. Found: C, 74.02; H, 8.35.

### Example 5

### Preparation of 9,9-Dihexylfluorene-2,7-Bis(Trimethylene Boronate) (E)

To a mixture of 2,7-dibromofluorene (10 g, 30.86 mmol) and a catalyst amount of triethylbenzylammonium chloride in 50 mL of DMSO and 12 mL of 50% aqueous NaOH, 1-bromohexane (12.74 g, 77.2 mmol) was added. The reaction mixture was cooled to room temperature and stirred for five hours. An excess of ethyl acetate was added to the reaction mixture, and the NaOH precipitate was filtered off. The organic layer was washed with dilute HCI (200 mL) and H₂O (2×150 mL), and dried. The pure product of 2,7-dibromo-9,9-dihexylfluorene was recrystallized from ethanol and dried under vacuum for further use. A solution of 2,7-dibromo-9,9-dihexylfluorene (16.3 g, 33 mmol) in THF was added slowly with stirring to a mixture of magnesium turnings (1.9 g, 80 mmol) and THF under argon. The Grignard reagent solution was slowly dropped into a stirred solution of trimethyl borate (38 mL, 330 mmol) in THF at −78° C. for two hours and then at room temperature for two days. The reaction mixture was poured into crushed ice containing sulfuric acid (5%) while stirring. The mixture was extracted with ether and the combined extracts were evaporated to give a white solid. Recrystallization of the crude acid from hexane-acetone (1:2) afforded pure 9,9-dihexylfluorene-2,7-diboronic acid (6.3 g, 44%) as white crystals. The diboronic acid (6.3 g, 15 mmol) was then refluxed with 1,3-propandiol (2.0 g, 33 mmol) in toluene for ten hours. After working up, the crude product was recrystallized from hexane to afford Compound E (5.50 g, 73%) as white crystals. Mp: 123.0-123.8° C. ¹H NMR (CDCI₃, 300 MHz, ppm) δ 7.77 (d, 2H, J=7.55 Hz), 7.72 (s, 2H), 7.69 (d, 2H, J=7.48 Hz), 4.25-4.16 (t, 8H, J=5.36 Hz), 2.07(m, 4H, J=5.33 Hz), 1.98 (m, 4H, J=4.09 Hz), 1.20-0.90(m, 12H), 0.76(t, 6H, J=6.83 Hz). 0.56(m, 4H). ¹³C NMR (CDCI₃, 75 MHz, ppm) δ 151.17, 140.03, 139.18, 132.44, 128.10, 123.53, 119.83, 109.94, 55.09, 40.28, 31.53, 31.43, 30.82, 29.62, 29.04, 28.71, 23.76, 22.48, 13.94, 13.88. Anal. Calcd for C₃₁H₄₄O₄B₂: C, 74.13; H, 8.83. Found: C, 74.02; H, 8.35.

### Example 6

### Preparation of Poly{2,5-Bis[3-(N,N-Dimethylamino)-1-Oxapropyl]-1,4-Phenyl}-co-alt-2,7-(9,9-Dihexylfluorene) (F)

To the mixture of 9,9-dihexylfluorene-2,7-bis(triethylene boronate) (251 mg, 0.499 mmol), 2,5-bis[3-(N,N-diethylamino)-1-oxapropyl]-1,4-dibromobenzene (233 mg, 0.500 mmol), tetrabutylammonium chloride (80 mg) and tetrakis(triphenylphosphine) palladium [Pd(PPh₃)₄] (12 mg), was added a degassed mixture of 3 mL of toluene ([monomer]=0.25 M) and 2 mL of 2 M potassium carbonate aqueous solution. The mixture was vigorously stirred at 75° C. for 48 hours. After the mixture was cooled down to room temperature, it was poured into 200 mL of methanol and deionized water (10:1). A fibrous solid was obtained by filtration. The solid was washed with methanol, water and then methanol. After washing for 24 hours in a Soxhlet apparatus with acetone to remove the oligomers and the catalyst residues, the resulting polymer F (370 mg, 57.1%) was obtained as an off-white fibrous solid. ¹H NMR (300 MHz, CDCI₃, ppm) δ 7.80-7.78 (br, 2H), 7.60 (br, 4H), 7.12 (s, 2H), 4.17 (br, 4H, —OCH₂), 2.92 (br, 4H, —CH₂N), 2.66 (br, 8H, —NCH₂CH₃), 2.05 (br, 4H), 1.12-0.78 (br, 34H). FT-IR (KBr, cm⁻¹): 2962, 2927, 2856, 2810, 1509, 1461, 1381, 1203, 1132, 1052, 1035, 888, 870, 822, 753. C₄₃H₆₂O₂N₂ H₂O. Anal. Calcd: C, 80.82; H, 9.84; N, 4.27. Found: C, 79.68; H, 9.79; N, 4.35.

### Example 7

### Preparation of Poly{2,5-bis[3-(N,N-Diethyl-N-Ethylamino)-1-Oxapropyl]-1,4-Phenyl}-co-alt-2,7-(9,9-Dihexylfluorene) Dibromide (G)

A 100 mL flask with a magnetic spin bar was charged with the polymer F (100 mg) dissolved in 50 mL of THF. To this solution was added bromoethane (1.09 g, 10.0 mmol) and 12 mL of DMSO. The solution was stirred at 50° C. for two days, and another portion of bromoethane (0.54 g, 5.0 mmol) was added on the third day. After the solution was stirred at 50° C. for five days, THF and extra bromoethane were evaporated. The polymer was precipitated by the addition of about 100 mL of acetone to the flask, collected by centrifugation, washed with chloroform, acetone, and dried overnight in vacuo at 50° C. The desired polymer G (62 mg, 50.1%) was obtained as light pink color powders. ¹H NMR (300 MHz, CD₃OD, ppm) δ 7.80-7.78 (br, 2H), 7.60 (br, 4H), 7.12 (s, 2H), 4.45 (br, 4H, —OCH₂), 3.55 (br, 4H, —CH₂N), 3.20 (br, 11.2H, —NCH₂CH₃), 2.05 (br, 4H), 1.12-0.78 (br, 39H). FT-IR (KBr, cm⁻¹): 2927, 2855, 2622, 2472, 1622, 1511, 1462, 1394, 1202, 1039, 829, 771.

### Example 8

### Preparation of Poly{2,5-Bis[3-(N,N,N-Triethylamino)-1-Oxapropyl]-1,4-Phenyl}-co-alt-2,7-(9,9-Dihexylfluorene) Dibromide (H)

According to the procedure for G after 100 mg of F was treated with bromoethane in DMSO/THF (1:4) at room temperature for two days, the desired polymer H (54 mg, 46.2%) was obtained as light pink color powders. ¹H NMR (300 MHz, CD₃OD, ppm) δ 7.80-7.78 (br, 2H), 7.60 (br, 4H), 7.12 (s, 2H), 4.45 (br, 4H, —OCH₂), 3.55 (br, 4H, —CH₂N), 3.20 (br, 10.4H, —NCH₂CH₃), 2.05 (br, 4H), 1.12-0.78 (br, 37H). FT-IR (KBr, cm⁻¹): 2925, 2855, 2629, 2475, 1622, 1511, 1462, 1393, 1202, 1030, 829, 754.

### Example 9

### Preparation of Poly{2,5-Bis[3-(N,N,N-Triethylamino)-1-Oxapropyl]-1,4-Phenyl}-co-alt-2,7-(9,9-Dihexylfluorene) Dibromide (I)

According to the procedure for G, after 100 mg of F was treated with bromoethane in THF at room temperature for 24 h, the desired polymer I (72 mg, 66.2%) was obtained as off-white powders. ¹H NMR (300 MHz, CDCI₃, ppm) δ 7.80-7.78 (br, 2H), 7.60 (br, 4H), 7.12 (s, 2H), 4.17 (br, 4H, —OCH₂), 2.92 (br, 4H, —CH₂N), 2,66 (br, 9.2H, —NCH₂CH₃), 2.05 (br, 4H), 1.12-0.78 (br, 36H). FT-IR (KBr, cm⁻¹): 2966, 2927 (weak), 2857 (weak), 1509, 1461, 1381, 1202, 1050, 887, 822, 753.

### Example 10

### Preparation of Poly {2,5-Bis[3 -(N,N,N-Triethylamino)-1-Oxapropyl]-1,4-Phenyl}-co-alt-2,7-(9,9-Dihexylfluorene) Dibromide (J)

To the mixture of 9,9-dihexylfluorene-2,7-bis(triethylene boronate) (504 mg, 1.01 mmol), 2,5-bis[3-(N, N, N-diethylammonium)-1-oxapropyl]-1,4-dibromobenzene dibromide (673 mg, 1.00 mmol), Pd(OAc)₂ (20 mg) was added a degassed mixture of 10 ml DMF and 4 mL of 2 M potassium carbonate aqueous solution. The mixture was vigorously stirred at 80° C. for 48 hours. After the mixture was cooled down to room temperature, it was poured into 200 mL of deionized water. The solvent was dialysized with a 5000 cut-off membrane. The solution was then filtered through a medium-porosity sintered glass funnel to give a clear solution. The solvent was evaporated, and the residue was washed with acetone. After drying, polymer J (320 mg, 31.8%) was obtained as dark gray solid. ¹H NMR (300 MHz, CD₃OD, ppm) δ 7.80-7.78 (br, 2H), 7.60 (br, 4H), 7.12 (s, 2H), 4.45 (br, 4H, —OCH₂), 3.55 (br, 4H, —CH₂N), 3.20 (br, 11.2H, —NCH₂CH₃), 2.05 (br, 4H), 1.12-0.78 (br, 39H). FT-IR (KBr, cm⁻¹): 2927, 2855, 2622, 2472, 1622, 1511, 1462, 1394, 1202, 1039, 829, 771.

It should be noted that the polymers, quaternized salts, methods and routes that have been shown here are exemplary and the score of the invention is not limited to those. As mentioned above, various polymers can be prepared as described by Formula 1. Changing the variables, R₁ to R₆, A, B, C, D, E, F, x and y also contributes to the different kinds of materials that have been covered. Other aspects, advantages and modifications within the scope of this invention will be apparent to those skilled in the art to which the invention pertains.

1. A conjugated polymer comprising the formula: 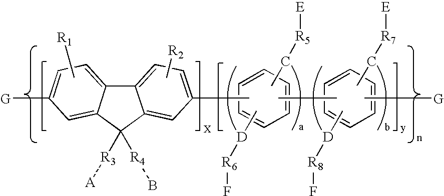
wherein:
R₁ and R₂ are identical or different and are each H, a straight or branched alkyl, alkoxyl, ester groups or cyclic crown ether groups having from 1 to about 22 carbon atoms;
A, B, E and F are identical or different and are each H, SiR′R″ or NR′R″ (wherein at least one of A, B, E and F is NR′R″); R′ and R″ are independently selected from the group consisting of hydrogen, unbranched or branched alkyl or alkoxyl groups having 1 to about 12 carbon atoms, and (C3 to C10) cycloalkyl groups;
C and D are identical or different and are each H (but are not both H), O, S, CO, COO, CRR′, NR′, SiR′R″, wherein R′ and R″ are as defined above;
R₃ and R₄ are identical or different and are independently selected from linear, branched or cyclical saturated or unsaturated aliphatic moieties that contain at least one heteroatom:
R₅, R₆, R₇ and R₈ are identical or different and are independently selected from linear, branched or cyclical saturated or unsaturated aliphatic moieties that contain at least one heteroatom and that contain at least one aromatic group, substituted or unsubstituted aromatic moiety;
G is hydrogen, halogen, boronic acid, boronate radical or an aryl moiety;
a and b are independently selected and each is a number from 0 to about 100, wherein if a is 0, b is a number from 1 to about 100 and if b is 0 a is a number from 1 to about 100;
x and y are independently selected and each is a number from 1 to about 100; and
n is a number from 1 to about 1000.

2. The conjugated polymer according to claim 1, wherein the conjugated polymer is a homopolymer.

3. The conjugated polymer according to claim 1, wherein the conjugated polymer is a random copolymer.

4. The conjugated polymer according to claim 1, wherein the conjugated polymer is an alternated copolymer.

5. The conjugated polymer according to claim 1, wherein R₁ and R₂ are H or straight or branched alkyl groups having from 1 to about 12 carbon atoms.

6. The conjugated polymer according to claim 1, wherein R₁ and R₂ are alkoxyl groups with from 1 to about 12 carbon atoms.

7. The conjugated polymer according to claim 1, wherein R′ and R″ are alkyl or alkoxyl groups having from 1 to 4 carbon atoms.

8. The conjugated polymer according to claim 1, wherein A, B, E and F are independently selected from hydrogen or NR′R″ (but not all are hydrogen).

9. The conjuated polymer according to claim 1, wherein R₃ and R₄ are linear or branched aliphatic chains having at least one of from 1 to 4 carbon atoms containing at least one heteroatom and at least one aromatic group.

10. The conjugated polymer according to claim 1, wherein R₃ and R₄ are alkoxyl groups having from 2 to about 12 carbon atoms.

11. The conjugated polymer according to claim 1, wherein R₅, R₆, R₇ and R₈ are linear or branched aliphatic chains having from 1 to about 8 carbon atoms containing at least one heteroatom.

12. The conjugated polymer according to claim 1, wherein R₅, R₆, R₇ and R₈ are alkoxyl groups having from 2 to about 12 carbon atoms.

13. The conjugated polymer according to claim 1, wherein x and y are each a number between 1 and 20.

14. The conjugated polymer according to claim 13, wherein x and y are each a number between 1 and 10.

15. The conjugated polymer according to claim 1, wherein a and b are each a number between 0 and 10.

16. The conjugated polymer according to claim 1, wherein n is a number between 1 and about 50.

17. The conjugated polymer according to claim 1, wherein G is an aryl moiety containing halogen, boronic acid or boronate radical.

18. The conjugated polymer according to claim 1, wherein G is hydrogen or an unsubstituted or substituted aryl moiety which does not contain halogen, boronic acid or boronate radical.

19. The conjugated polymer according to claim 1, wherein a linkage between fluorene and phenylene in the conjugated polymer is on the 1 and 4 positions.

20. The conjugated polymer according to claim 1, wherein the conjugated polymer comprises a backbone comprising extended phenylene units.

21. The conjugated polymer according to claim 1, wherein the conjugated polymer comprises a backbone comprising extended fluorene units.

22-31. (canceled)

32. A method of forming a conjugated cationic polymer having a desired solubility in a given solvent, comprising:
providing a conjugated cationic polymer comprising the formula: 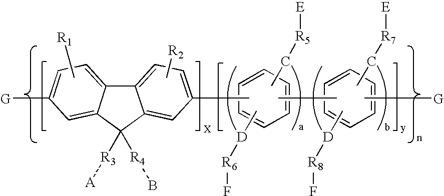
wherein:
R₁ and R₂ are identical or different and are each H, a straight or branched alkyl, alkoxyl, ester groups or cyclic crown ether groups having from 1 to about 22 carbon atoms;
A, B, E and F are identical or different and are each H, SiR′R″ or NR′R″ (wherein at least one of A, B, E and F is NR′R″; R′ and R″ are independently selected from the group consisting of hydrogen, unbranched or branched alkyl or alkoxyl groups having 1 to about 12 carbon atoms, and (C3 to C10) cycloalkyl groups;
C and D are identical or different and are each H (but are not both H), O, S, CO, COO, CRR′, NR′, SiR′R″, wherein R′ and R″ are as defined above;
R₃ and R₄ are identical or different and are independently selected from linear, branched or cyclical saturated or unsaturated aliphatic moieties that contain at least one heteroatom;
R₅, R₆, R₇ and R₈ are identical or different and are independently selected from linear, branched or cyclical saturated or unsaturated aliphatic moieties that contain at least one heteroatom and that contain at least one aromatic group, substituted or unsubstituted aromatic moiety;
G is hydrogen, halogen, boronic acid, boronate radical or an aryl moiety;
a and b are independently selected and each is a number from 0 to about 100, wherein if a is 0, b is a number from 1 to about 100 and if b is 0, a is a number from 1 to about 100;
x and y are also independent independently selected and each is a number from 1 to about 100; and
n is a number from 1 to about 1000; and
quaternizing terminal amino groups of the conjugated cationic polymer.

33. The method according to claim 32, wherein quaternizing terminal amino groups of the conjugated cationic polymer comprises guaternizing between about 30% and about 80% of the terminal amino groups.

34. The method according to claim 32, wherein quaternizing terminal amino groups of the conjugated cationic polymer comprises treating the conjugated cationic polymer with an alkyl halide.

35. The method according to claim 34, wherein treating the conjugated cationic polymer with an alkyl halide comprises treating the terminal amino groups with bromoethane.

36. The method according to claim 35, wherein treating the terminal amino groups with bromoethane comprises stirring the conjugated cationic polymer with bromoethane in dimethyl sulfoxide (DMSO) and tetrahydrofliran (THF).

37. The method according to claim 36, wherein stirring the conjugated cationic polymer with bromoethane in DMSO and THF comprising a ratio of DMSO:THF of about 1:4, and wherein stirring the conjugated cationic polymer with bromoethane in DMSO and THF comprises stirring the conjugated cationic polymer at about 50° C. for about 5 days.

38. The method according to claim 35, wherein treating the terminal amino groups with bromoethane comprises stirring the conjugated cationic polymer with bromoethane in tetrafurohydran.

39. The method according to claim 38, wherein stirring the conjugated cationic polymer with bromoethane in tetrafurohydran comprises stirring the conjugated cationic polymer at about room temperature for about 24 hours.

40. The method according to claim 36, further comprising:
evaporating the DMSO and THF;
precipitating the quaternized conjugated cationic polymer;
washing the quaternized conjugated cationic polymer; and
drying the quaternized conjugated cationic polymer.

41. The method according to claim 40, wherein precipitating the quaternized conjugated cationic polymer comprises adding acetone to the quaternized conjugated cationic polymer followed by centrifugation.

42. The method according to claim 40, wherein washing the quaternized conjugated cationic polymer comprises washing the quaternized conjugated cationic polymer with at least one of chloroform and acetone.

43-46. (canceled)

47. The conjugated polymer according to claim 1, wherein the conjugated polymer comprises repeating units of the formula: 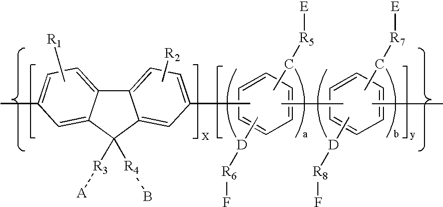
wherein:
in at least one of the repeating units, at least one of A, B, E and F is NR′R″R′″, wherein R′, R″ and R′″ are independently selected from the group consisting of hydrogen, unbranched or branched alkyl or alkoxyl groups having 1 to about 12 carbon atoms, and (C₃ to C₁₀) cycloalkyl groups.

48. The conjugated polymer according to claim 47, wherein at least one of R′, R″ and R′″ is hydrogen.

49. The conjugated polymer according to claim 48, wherein at least one of A, B, E and F is ammonium.

50. The conjugated polymer according to claim 49, wherein the ammonium is quaternized from at least one amino substituent of the conjugated polymer.

51. The conjugated polymer according to claim 49, wherein at least one of A, B, E and F is ammonium in at least one of the repeating units.

52. The conjugated polymer according to claim 51, wherein at least two of A, B, E and F are ammonium in at least one of the repeating units.

53. The conjugated polymer according to claim 50, wherein between about 30% and about 60% of terminal amino substituents in the conjugated polymer are quaternized to ammonium.

54-59. (canceled)

60. The method according to claim 32, wherein providing a conjugated cationic polymer comprises:
providing monomer precursors of the conjugated cationic polymer;
quaternizing terminal amino groups of the monomer precursors; and
synthesizing the conjugated cationic polymer from the quaternized monomer precursors.

61. The method according to claim 60, wherein synthesizing the conjugated cationic polymer from the quaternized monomer precursors comprises synthesizing the conjugated cationic polymer by the Suzuki coupling reaction.

62. The method according to claim 60, further comprising determining the desired solubility of the conjugated cationic polymer and calculating the amount of monomer precursors required to form a conjugated cationic polymer having the desired solubility.

63. The method according to claim 60, further comprising determining the desired solubility of the conjugated cationic polymer and quaternizing the terminal amino groups to a degree sufficient to result in the conjugated cationic polymer having the desired solubility.

64. The method according to claim 32, wherein quaternizing terminal amino groups of the conjugated cationic polymer comprises increasing the solubility of the conjugated cationic polymer in a polar solvent.

65. The method according to claim 32, wherein quaternizing terminal amino groups of the conjugated cationic polymer comprises quaternizing the terminal amino groups to an extent necessary to increase the solubility of the conjugated cationic polymer to the desired solubility.
